(19) United States
(12) Patent Application Publication
(10) Pub. No.: US 2023/0260159 A1
(43) Pub. Date: Aug. 17, 2023

(54) INFORMATION PROCESSING APPARATUS, INFORMATION PROCESSING METHOD, AND NON-TRANSITORY COMPUTER READABLE MEDIUM

(71) Applicant: CANON KABUSHIKI KAISHA, Tokyo (JP)

(72) Inventor: Shogo Sato, Kanagawa (JP)

(21) Appl. No.: 18/157,873

(22) Filed: Jan. 23, 2023

(30) Foreign Application Priority Data
Feb. 15, 2022 (JP) 2022-021445

(51) Int. Cl. G06T 7/80; G06T 5/50; G06T 5/00; G06T 3/20; G06T 3/40

(52) U.S. Cl. CPC G06T 7/85; G06T 5/50; G06T 5/006; G06T 3/20; G06T 3/40; G06T 2207/30204

(57) ABSTRACT

An information processing apparatus acquires two images; detects a mark from each of the images; acquires a correction value for at least one of the images on a basis of a positional relationship in a height direction between the marks in the images; determines a parallax between the images on a basis of the images and the correction value; and corrects the parallax or a depth position corresponding to the parallax on a basis of a positional relationship between the marks in the images and the correction value, wherein the correction value includes at least one of a correction value for enlarging or reducing at least one of the images and a correction value for moving at least one of the images in the height direction.

### BACKGROUND OF THE INVENTION

### Field of the Invention

The present invention relates to an information processing apparatus, an information processing method, and a non-transitory computer readable medium, and particularly relates to a technique for obtaining a depth position of a photographed scene and a parallax corresponding to the depth position.

### Description of the Related Art

In the case where a depth position of a photographed scene is measured from two images photographed from directions which are different from each other (e.g., two images photographed by a stereo camera), the depth position is measured in consideration of a camera parameter such as a camera external parameter or a camera internal parameter. The camera external parameter includes information on, e.g., a positional relationship and an attitude relationship between two cameras which photograph the above two images (e.g., a position and attitude of one camera relative to those of another camera). The camera internal parameter includes information on, e, g., a focal length and a principal point position of each camera.

For example, an epipolar line on the photographed image of the other camera which corresponds to a point shown at a given position on the photographed image of one of the cameras (a line made up of a plurality of positions at which a given point may be shown) is determined based on the camera parameter. Subsequently, a search for a position corresponding to the given position on one of the photographed images is made from the epipolar line. It is possible to estimate, from two positions corresponding to each other between the two photographed images, a three-dimensional position (including a depth position) of a point shown at the two positions by using the camera parameter. It is possible to obtain the depth position of the entire photographed scene by searching for the position on the other photographed image corresponding to the position on one of the photographed images for all positions on one of the photographed images.

In order to facilitate the search, there are cases where stereo rectification is performed by using the camera parameter. The stereo rectification is processing for obtaining virtual two photographed images in which it seems that two cameras have only moved in parallel in a left-to-right direction without changing their angles. By performing the stereo rectification, a line which is at the same height as that of a given position on one of the photographed images (a position in a vertical direction, a position in a longitudinal direction, a position in an up-and-down direction) and is parallel to a horizontal direction (a lateral direction, a left-to-right direction) serves as the epipolar line of the other photographed image corresponding to the given position. That is, by performing the stereo rectification, a given point is shown in each of the two photographed images at the same height, and hence it is only necessary to refer to the same height in the other photographed image as that of the given position on one of the photographed images, and the search is thereby facilitated.

There are cases where the camera parameter changes. When the camera parameter changes, an error in the obtained depth position is increased. In particular, when an error in the result of the stereo rectification (a positional displacement in a height direction (a vertical direction, a longitudinal direction, an up-and-down direction) between the two photographed images) is increased, it is not possible to accurately determine the two positions which correspond to each other between the two photographed images, and it is not possible to obtain the accurate depth position.

In a method described in Japanese Patent Application Publication No. 2013-113600, a photographed image is shifted in a height direction by one pixel at a time, and a positional displacement in the height direction between two photographed images is thereby reduced. In a method described in Japanese Patent Application Publication No. 2018-112522, rotation and translation of one or both of two pixels which correspond to each other between two photographed images are performed.

However, in the method described in Japanese Patent Application Publication No. 2013-113600, a series of processing operations including searching is repeated while the photographed image is shifted in the height direction by one pixel at a time, and hence the processing requires a long time period. In the method described in Japanese Patent Application Publication No. 2018-112522, a search has to be performed on the whole of the other photographed image for each pixel of one of the photographed images, and hence the processing requires a long time period. Further, in the method described in Japanese Patent Application Publication No. 2018-112522, it is possible to correct only the pixel of which the search is successful. In addition, in each of the method described in Japanese Patent Application Publication No. 2013-113600 and the method described in Japanese Patent Application Publication No. 2018-112522, in the case where the focal lengths of the two cameras are different from each other, it is not possible to correct the depth position with high accuracy.

### SUMMARY OF THE INVENTION

The present invention provides a technique capable of obtaining, for instance, a depth position of a photographed scene and a parallax corresponding to the depth position with high accuracy in a short time period.

The present invention in its first aspect provides an information processing apparatus including at least one memory and at least one processor and/or at least one circuit which function as: an image acquisition unit configured to acquire a first image captured from a first direction and a second image captured from a second direction; a mark detection unit configured to detect a mark from each of the first image and the second image; a correction value acquisition unit configured to acquire a correction value for at least one of the first image and the second image on a basis of a positional relationship in a height direction between the mark in the first image and the mark in the second image; a parallax determination unit configured to determine a parallax between the first image and the second image on a basis of the first image, the second image, and the correction value; and a correction unit configured to correct the parallax determined by the parallax determination unit or a depth position corresponding to the parallax on a basis of a positional relationship between the mark in the first image and the mark in the second image and the correction value, wherein the correction value includes at least one of a correction value for enlarging or reducing at least one of the first image and the second image and a correction value for moving at least one of the first image and the second image in the height direction.

The present invention in its second aspect provides an information processing method including: acquiring a first image captured from a first direction and a second image captured from a second direction; detecting a mark from each of the first image and the second image; acquiring a correction value for at least one of the first image and the second image on a basis of a positional relationship in a height direction between the mark in the first image and the mark in the second image; determining a parallax between the first image and the second image on a basis of the first image, the second image, and the correction value; and correcting the parallax or a depth position corresponding to the parallax on a basis of a positional relationship between the mark in the first image and the mark in the second image and the correction value, wherein the correction value includes at least one of a correction value for enlarging or reducing at least one of the first image and the second image and a correction value for moving at least one of the first image and the second image in the height direction.

The present invention in its third aspect provides a non-transitory computer readable medium that stores a program, wherein the program causes a computer to execute an information processing method including: acquiring a first image captured from a first direction and a second image captured from a second direction; detecting a mark from each of the first image and the second image; acquiring a correction value for at least one of the first image and the second image on a basis of a positional relationship in a height direction between the mark in the first image and the mark in the second image; determining a parallax between the first image and the second image on a basis of the first image, the second image, and the correction value; and correcting the parallax or a depth position corresponding to the parallax on a basis of a positional relationship between the mark in the first image and the mark in the second image and the correction value, wherein the correction value includes at least one of a correction value for enlarging or reducing at least one of the first image and the second image and a correction value for moving at least one of the first image and the second image in the height direction.

Further features of the present invention will become apparent from the following description of exemplary embodiments with reference to the attached drawings.

### BRIEF DESCRIPTION OF THE DRAWINGS

FIG. 1 is a functional block diagram of a photographing system according to a first embodiment;

FIGS. 2A to 2C are flowcharts showing processing according to the first embodiment;

FIGS. 3A and 3B are views showing camera images after correction according to the first embodiment;

FIG. 4 is a view for explaining a calculation method of a depth correction amount according to the first embodiment;

FIG. 5 is a view for explaining the calculation method of the depth correction amount according to the first embodiment;

FIG. 6A is a view showing a temporal change of the depth correction amount according to the first embodiment;

FIGS. 6B and 6C are views showing temporal changes of a depth value according to the first embodiment;

FIG. 7 is a view of a hardware configuration of an information processing apparatus according to the first embodiment;

FIG. 8 is a functional block diagram of a photographing system according to a second embodiment; and

FIGS. 9A and 9B are flowcharts showing processing according to the second embodiment.

### DESCRIPTION OF THE EMBODIMENTS

### First Embodiment

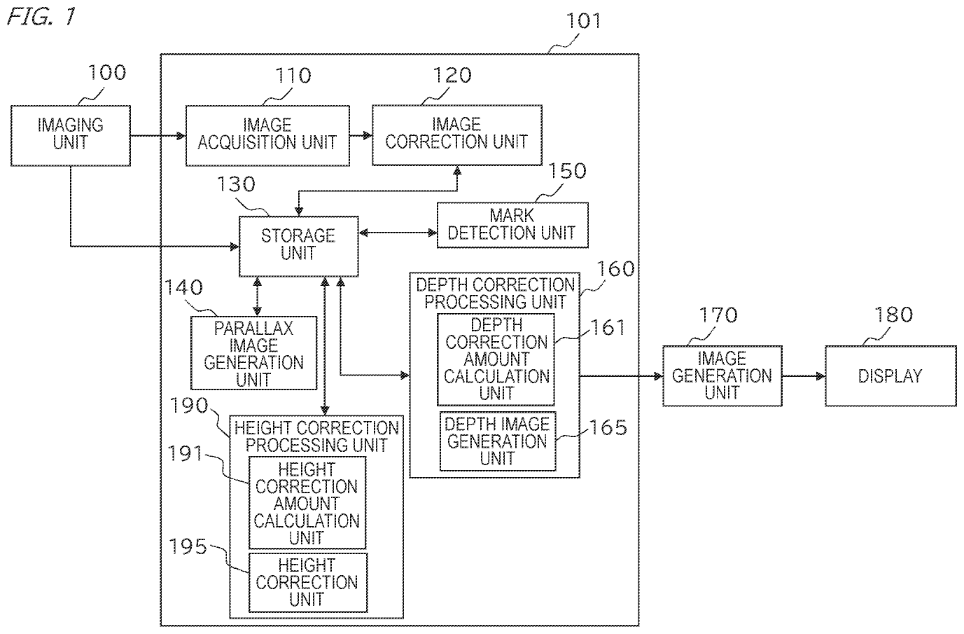

Hereinbelow, a first embodiment of the present invention will be described. FIG. 1 is a block diagram showing a functional configuration of a photographing system according to the first embodiment. As shown in FIG. 1, the photographing system includes an imaging unit 100, an information processing apparatus 101, an image generation unit 170, and a display 180. Note that the configuration shown in FIG. 1 is an example, and is not intended to limit the present invention. For example, the imaging unit 100 may be an imaging apparatus independent of the information processing apparatus 101, and the imaging unit 100 and the information processing apparatus 101 may also be integrated with each other. The function of the information processing apparatus 101 may be implemented by a plurality of apparatuses, and the information processing apparatus 101 may include the image generation unit 170 and the like. The display 180 may be a display apparatus independent of the information processing apparatus 101, and the display 180 and the information processing apparatus 101 may also be integrated with each other.

The imaging unit 100 is an imaging unit which performs photographing from a plurality of directions and, for example, a stereo camera in which two cameras for photographing a scene are fixed is used. Note that, when a condition in which the scene to be photographed does not change spatially is given, the present invention can be applied to a method in which a position attitude of one camera is constantly measured, and stereo matching (stereo measurement) is performed by using a plurality of images photographed (captured) from a plurality of directions by the camera.

The information processing apparatus 101 includes an image acquisition unit 110, an image correction unit 120, a storage unit 130, a parallax image generation unit 140, a mark detection unit 150, a height correction processing unit 190, and a depth correction processing unit 160.

The image acquisition unit 110 acquires an image (camera image) photographed by the imaging unit 100, and outputs the acquired image to the image correction unit 120.

The image correction unit 120 executes lens distortion correction and rectification for performing high-speed processing of a stereo camera image on the acquired image as correction processing. The image correction unit 120 reads a camera parameter required for the correction processing from the storage unit 130. In the lens distortion correction and the rectification, methods described in Japanese Patent Application Publication No. 2019-113434 and Japanese Patent Application Publication No. 2012-058188, or other known techniques may be used. The image correction unit 120 stores an image subjected to the correction processing (referred to as a camera image after correction in the present embodiment) in the storage unit 130.

The storage unit 130 is a module for storing and managing various pieces of information. The storage unit 130 stores, e.g., the following pieces of information.
Camera image after correction (a left image and a right image in the case of a twin-lens stereo camera)
Camera parameter (camera external parameters indicative of a positional relationship and an attitude relationship between two cameras (e.g., a relative position and attitude of the other camera with respect to one of cameras), and camera internal parameters indicative of a focal length and a principal point position of each camera)
Parallax image generated by the parallax image generation unit 140
Mark information (information input by a user in advance before height correction and depth correction are performed such as a marker ID serving as identification information of a marker disposed in photographed space and the length of a side of a rectangular area of the marker)
Mark detection information (the marker ID, coordinates of vertices of the rectangular area of the marker<X value, Y value>)
Past mark detection information (e.g., mark detection information corresponding to past ten frames)
Depth correction amount (a correction amount of a parallax, a correction amount of a depth)
Height correction amount (a correction amount of the focal length<X value, Y value> and a correction amount of the principal point position<Y value>

The information processing apparatus 101 reads the camera parameter stored in the imaging unit 100 from the imaging unit 100 when the storage unit 130 is initialized, and stores the camera parameter in the storage unit 130. In the case where the camera parameter is not present in the imaging unit 100, a calibration pattern for camera calibration may be photographed with the imaging unit 100 in advance, and the camera parameter may be calculated from image data.

Note that information stored by the storage unit 130 is not limited to information having the above data structure, and may be any information as long as the information is required to perform processing in each functional unit. In addition, the entire marker may be viewed as a mark of course, and the rectangular area of the marker may be viewed as a mark and the vertex of the rectangular area or the marker may also be viewed as a mark.

The parallax image generation unit 140 determines (parallax determination) a parallax (a parallax between the left image and the right image) in the camera image after correction based on the camera image after correction and the camera parameter stored in the storage unit 130, and generates a parallax image. The parallax image is an image which shows, e.g., a parallax of each pixel. In the generation of the parallax image, as described in Japanese Patent Application Publication No. 2019-113434 and Japanese Patent Application Publication No. 2012-058188, a method which determines the parallax of each pixel by performing matching of images acquired by a stereo camera (Sum of Absolute Difference or the like) may also be used. In the case where stereo rectification is performed properly (with high accuracy), when matching which searches for a pixel corresponding to a given pixel in one of images from the other image (stereo matching) is performed, it is only necessary to refer to the same height in the other image as that of the given pixel in one of the images. That is, it is possible to narrow a search area in the other image down to an area including a plurality of positions at the same height as that of the given pixel in one of the images. The parallax image generation unit 140 stores the generated parallax image in the storage unit 130.

In the case where the mark is shown in the camera image after correction (each of the left image and the right image) stored in the storage unit 130, the mark detection unit 150 detects the shown mark from the camera image after correction. Subsequently, the mark detection unit 150 stores information on the detected mark (mark detection information) in the storage unit 130.

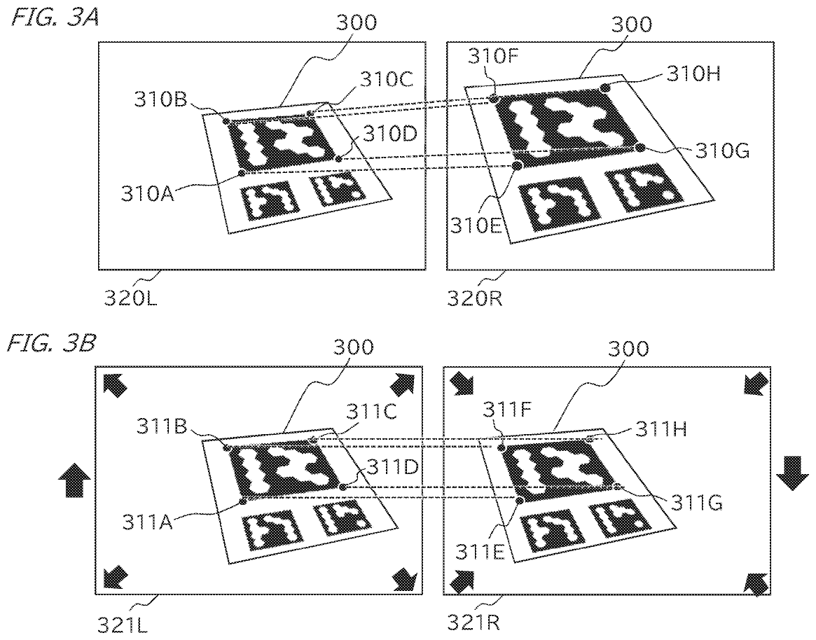

As the mark, for example, as shown in FIG. 3A, the marker having the rectangular area including a square is used. In the detection of the mark, detection processing of a rectangular marker (ArUco or the like) having an ID may be used. For example, the mark detection unit 150 may detect the rectangular area from the camera image after correction, identify a bit pattern disposed in the rectangular area with homography transformation, and output the marker ID and coordinates of four vertices of the rectangular area.

An example of the detection of the mark will be described with reference to FIG. 3A. FIG. 3A shows a left image 320L and a right image 320R which are camera images after correction. Each of the left image 320L and the right image 320R has a marker 300, and the mark detection unit 150 detects four vertices of the rectangular area of the marker 300. FIG. 3A shows an example of the case where the camera parameter has changed from that at the time of rectification. Accordingly, four vertices 310A to 310D in the left image 320L and four vertices 310E to 310H in the right image 320R are detected at different heights. If the camera parameter does not change from that at the time of rectification, the four vertices 310A to 310D and the four vertices 310E to 310H are detected at the same height. The mark detection unit 150 stores coordinates of the four vertices 310A to 310D and coordinates of the four vertices 310E to 310H in the storage unit 130. Instead of or in addition to the vertices of the rectangular area, the center position of the rectangular area, vertices of the marker, and the center position of the marker may also be detected.

The mark detection unit 150 sequentially determines whether or not the mark is shown in the camera image after correction which is acquired by the image acquisition unit 110 at regular intervals and is corrected by the image correction unit 120. Subsequently, in the case where the mark is shown in the camera image after correction, the mark detection unit 150 outputs mark detection information to the storage unit 130, and updates the mark detection information in the current frame. In the case where the mark is not shown in the camera image after correction, the mark detection unit 150 outputs information indicating that the mark is not present as the mark detection information. In the case where a plurality of markers are detected from one image, the mark detection unit 150 associates the ID of the marker with the coordinates of the four vertices of the rectangular area of the marker for each detected marker, and stores them in the storage unit 130.

The height correction processing unit 190 reads the mark detection information and the camera image after correction stored in the storage unit 130, and performs acquisition (calculation, determination) of a height correction amount, and correction (height correction) of the mark detection information and the camera image after correction. As shown in FIG. 1, the height correction processing unit 190 includes a height correction amount calculation unit 191 and a height correction unit 195.

The height correction amount calculation unit 191 reads the mark detection information from the storage unit 130, and acquires (calculates, determines) the height correction amount based on the mark detection information. The height correction amount is the correction amount (a correction value, correction information, a parameter) for at least one of the left image and the right image. The height correction amount may be viewed as the correction amount for the left image, may be viewed as the correction amount for the right image, and may also be viewed as the sum of the correction amounts therefor.

For example, the height correction amount calculation unit 191 determines that the vertex 310A in the left image 320L and the vertex 310E in the right image 320R in FIG. 3A are the same points in three-dimensional space and associates the vertices 310A and 310E with each other. Similarly, the height correction amount calculation unit 191 associates the vertices 310B to 310D with the vertices 310F to 310H, respectively. A method for associating the vertices is not particularly limited. For example, when the vertex is detected, the mark detection unit 150 may determine a vertex ID corresponding to the relative position of the vertex with respect to the rectangular area, and include the vertex ID in the mark detection information. In this case, it is only required that the height correction amount calculation unit 191 associates two vertices having the same vertex ID (the vertex in the left image and the vertex in the right image) with each other. As described above, the vertices 310A to 310H may be viewed as the marks.

Subsequently, the height correction amount calculation unit 191 acquires the height correction amount (correction value acquisition) based on the positional relationships in the height direction between the vertices 310A to 310D and the vertices 310E to 310H, and stores the height correction amount in the storage unit 130. The height correction amount calculation unit 191 acquires, as the height correction amount, a correction amount (correction value) for reducing positional displacements (errors) in the height direction between the vertices 310A to 310D and the vertices 310E to 310H. For example, the height correction amount calculation unit 191 acquires the correction amount for minimizing the above error as the height correction amount. Examples of the above error include an average, maximum value, and sum of a displacement amount (an absolute value of a difference) between the heights of the associated two vertices. By correcting at least one of the left image and the right image based on the height correction amount obtained in this manner, it is possible to implement a state in which stereo rectification is performed properly (with high accuracy). By extension, in the parallax image generation unit 140, it becomes possible to perform preferable stereo matching (stereo matching which refers only to, in the other image, the same height as that of a given pixel in one of images).

When the focal length changes, a photographing area is enlarged or reduced, and hence the change of the focal length is seen as the enlargement or reduction of an object in an image. When the principal point position changes, the photographing area is moved, and hence the change of the principal point position is seen as the movement of the entire object in the image. To cope with this, the height correction amount calculation unit 191 may acquire, as the height correction amounts, a scaling parameter for enlarging or reducing at least one of the left image and the right image, and a movement parameter for moving at least one of the left image and the right image in the height direction. When the left image or the right image is corrected with the scaling parameter (focal length correction amount), it becomes possible to implement the state in which the stereo rectification is performed properly (with high accuracy) even in the case where the focal length differs from one camera to another and even in the case where the focal length has changed. Similarly, when the left image or the right image is corrected with the movement parameter (principal point position correction amount), it becomes possible to implement the state in which the stereo rectification is performed properly (with high accuracy) even in the case where the principal point position differs from one camera to another and even in the case where the principal point position has changed.

Note that, in the case where an image size (resolution) in a horizontal direction (a lateral direction, a left-to-right direction) is different from that in a vertical direction (a longitudinal direction, an up-and-down direction, a height direction), it follows that a parameter in the horizontal direction and a parameter in the vertical direction are present as parameters related to the image size. Even in such a case, when it is assumed that what enlarges or reduces the object in the image is the focal length which is one physical quantity, for example, it is possible to express the scaling parameter with one parameter which is a rate of change from a reference focal length.

The height correction unit 195 reads the height correction amount from the storage unit 130, and corrects (position correction) position information (coordinates) of at least one of the mark (vertex) in the left image and the mark (vertex) in the right image based on the height correction amount. Subsequently, the height correction unit 195 updates the mark detection information stored in the storage unit 130 such that corrected coordinates are indicated. In addition, the height correction unit 195 reads the camera image after correction from the storage unit 130, and corrects (image correction, height correction) the camera image after correction (at least one of the left image and the right image) based on the height correction amount. Subsequently, the height correction unit 195 updates the camera image after correction stored in the storage unit 130 with the camera image after height correction.

A left image 321L in FIG. 3B is a result obtained by performing the height correction by the height correction unit 195 on the left image 320L in FIG. 3A, and a right image 321R is a result obtained by performing the height correction on the right image 320R. The vertices 310A to 310H in FIG. 3A are moved by the height correction, and become vertices 311A to 311H in FIG. 3B. Among the vertices 311A to 311H, associated two vertices are positioned at the same height. For example, the vertex 311A and the vertex 311E are positioned at the same height. Each of FIGS. 3A and 3B shows an example in which the height correction amount for minimizing change amounts in the left image and the right image due to the height correction is obtained. Enlargement and movement in an upward direction are performed on the left image 320L, and reduction and movement in a downward direction are performed on the right image 320R. Note that, in the height correction, without changing one of the left image and the right image, only the other image may be changed.

The depth correction processing unit 160 corrects (depth correction) a depth position corresponding to a parallax after height correction (a parallax determined based on the left image and the right image after height correction) based on a positional relationship after height correction between the mark (vertex) in the left image and the mark (vertex) in the right image. Specifically, the depth correction processing unit 160 reads the parallax image and the mark detection information (after height correction) stored in the storage unit 130, and corrects a depth image (an image showing a depth position (depth value) of each pixel) obtained from the parallax image. As shown in FIG. 1, the depth correction processing unit 160 includes a depth correction amount calculation unit 161 and a depth image generation unit 165.

The depth correction amount calculation unit 161 calculates the depth correction amount which is a correction amount (a correction value, correction information, a parameter) for depth correction.

For example, the depth correction amount calculation unit 161 refers to the mark detection information stored in the storage unit 130, and acquires coordinates of the vertices 311A to 311H of the rectangular areas of the markers 300 in the camera images after height correction (the left image 321L and the right image 321R in FIG. 3B). Similarly to the height correction amount calculation unit 191, the depth correction amount calculation unit 161 determines that the vertex 311A in the left image 321L and the vertex 311E in the right image 321R are the same points in three-dimensional space, and associates the vertices 311A and 311E with each other. Similarly, the depth correction amount calculation unit 161 associates the vertices 311B to 311D with the vertices 311F to 311H, respectively. Subsequently, the depth correction amount calculation unit 161 calculates the depth correction amount by the following method.

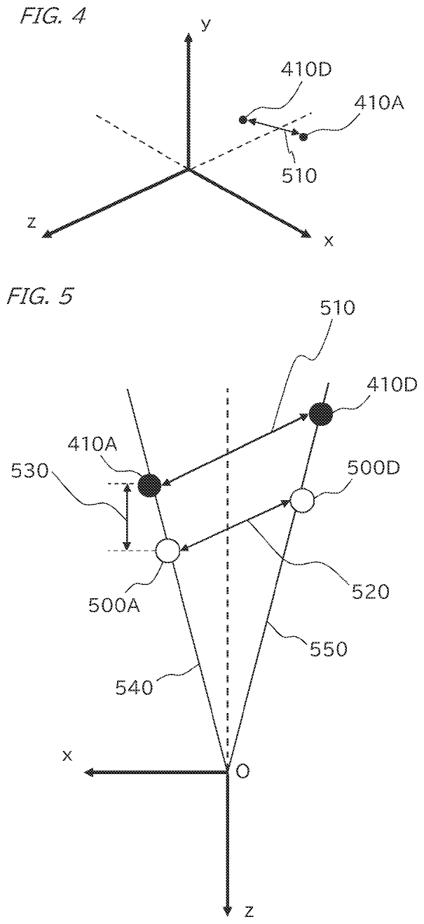

Processing of the depth correction amount calculation unit 161 will be described with reference to FIGS. 4 and 5. The description will be made by focusing attention only on the vertices 311A and 311D in the left image 321L after height correction, and the vertices 311E and 311H in the right image 321R after height correction in order to simplify the description.

When the vertex 311A and the vertex 311E are associated with each other and the vertex 311D and the vertex 311H are associated with each other, as shown in FIG. 4, it is possible to calculate three-dimensional points 410A and 410D in a coordinate system of a camera reference (camera coordinate system) by a known calculation method of triangulation. The depth correction amount calculation unit 161 calculates a distance between the point 410A and the point 410D (the length of a segment 510 linking the point 410A and the point 410D).

In addition, the depth correction amount calculation unit 161 refers to the mark information stored in the storage unit 130, and acquires the length of a side (the length of a segment 520 described later) of the rectangular area of the marker having the corresponding marker ID (the same marker ID as the marker ID indicated by the referenced mark detection information).

Next, as shown in FIG. 5, in the camera coordinate system, the depth correction amount calculation unit 161 sets a line 540 passing through the point 410A from the camera origin O and a line 550 passing through the point 410D from the camera origin O, and sets the segment 510 linking the point 410A and the point 410D.

Further, the depth correction amount calculation unit 161 estimates three-dimensional points 500A and 500D which are output in the case where an error is not present in the camera parameter. The points 500A and 500D are determined so as to satisfy the following conditions.

(1) The point 500A is on the line 540.

(2) The point 500D is on the line 550.

(3) The gradient of the segment 520 linking the point 500A and the point 500D is equal to the gradient of the segment 510.

(4) A distance between the point 500A and the point 500D (the length of the segment 520 linking the point 500A and the point 500D) is equal to the length of a side indicated by the mark information.

Subsequently, the depth correction amount calculation unit 161 sets a difference 530 between a Z value of the point 500A and a Z value of the point 410A as the depth correction amount.

The depth image generation unit 165 generates the depth image by calculating the depth value of each pixel from the parallax image stored in the storage unit 130. Subsequently, the depth image generation unit 165 corrects the depth image (depth correction) by adding the depth correction amount calculated in the depth correction amount calculation unit 161 to each depth value of the depth image. The depth image generation unit 165 outputs the depth image after depth correction to the image generation unit 170.

The image generation unit 170 generates an image including the acquired depth image (after depth correction), e.g., an application screen which displays the depth image, and displays the application screen on the display 180 such as a liquid crystal display or an organic EL display.

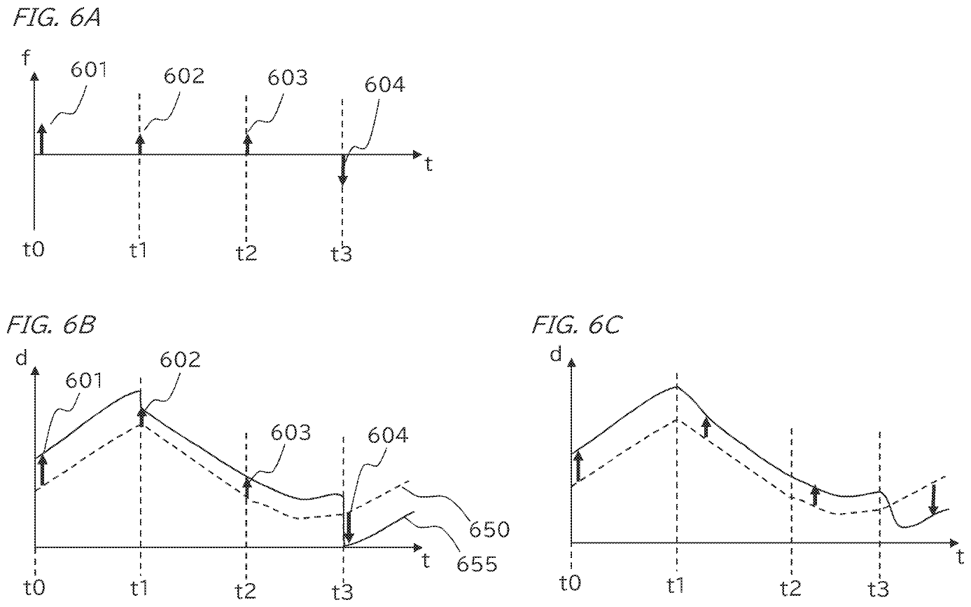

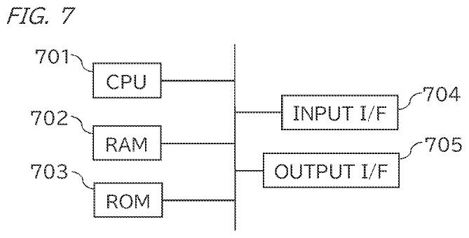

The processing of the depth correction processing unit 160 may be executed immediately after the image acquired in the image acquisition unit 110 is updated and the parallax image is generated, and may also be executed at regular intervals. For example, every time the parallax image corresponding to ten frames is generated, the depth correction amount may be calculated. A description will be given of temporal changes of the depth correction amount and the depth value in the case where the depth correction amount is calculated at regular intervals with reference to FIGS. 6A and 6B. In FIG. 6A, the horizontal axis indicates a time t, and the vertical axis indicates a depth correction amount f. As shown in FIG. 6A, a depth correction amount 601 is calculated at an interval from a time t0 to a time t1 and, thereafter, depth correction amounts 602, 603, . . . are calculated at regular intervals. In FIG. 6B, the horizontal axis indicates a time t, and the vertical axis indicates a depth value d. A broken line 650 indicates the depth value before depth correction, and a solid line 655 indicates the depth value after depth correction. As shown in FIG. 6B, when the depth correction amount f is calculated, the depth correction amount f is added to the depth value, and the same depth correction value f is reflected in a subsequent frame. The depth correction amount f added to the depth value is updated at each time (times t1, t2, . . . ).

Note that the depth image generation unit 165 may provide a weight in the depth correction amount f instead of reflecting the updated depth correction amount f without altering it. In FIG. 6C, the horizontal axis indicates a time t, and the vertical axis indicates a depth value d. In an example of FIG. 6C, the weight of the updated depth correction amount f is increased according to a lapse of time from the update of the depth correction amount f such that change of the depth value after depth correction is smoothed.

When the height correction processing unit 190 performs enlargement or reduction of the image based on the scaling parameter (focal length correction amount), the image size in the horizontal direction is changed and the parallax is changed, and hence there is a possibility that the error in the depth value (depth position) estimated by stereo matching may be increased. In the present embodiment, the depth correction processing unit 160 corrects the depth value, whereby it is possible to prevent such an increase of the error.

FIG. 7 is a view showing an example of a hardware configuration of the information processing apparatus 101. A CPU 701 controls the entire information processing apparatus 101 by using computer programs and data stored in a RAM 702 and a ROM 703. The RAM 702 is used as a work area when the CPU 701 performs processing. The ROM 703 stores a control program, various application programs, and data. The CPU 701 loads the control program stored in the ROM 703 into the RAM 702 and executes the control program, whereby processing of individual functional units of the information processing apparatus 101 shown in FIG. 1 is implemented. For example, processing of at least any of the image acquisition unit 110, the image correction unit 120, the storage unit 130, the parallax image generation unit 140, the mark detection unit 150, the height correction processing unit 190, and the depth correction processing unit 160 is implemented. An input I/F 704 inputs a signal (a camera image or the like) to the information processing apparatus 101 from the imaging unit 100. At this point, the input I/F 704 may convert the signal (input signal) from the imaging unit 100 into a signal of a form which can be processed by the information processing apparatus 101. An output I/F 705 outputs a signal to an external apparatus. At this point, the output I/F 705 may convert the signal to be output (output signal) into a signal of a form which can be processed by the external apparatus.

As described above, the processing (function) of the individual functional units of the information processing apparatus 101 shown in FIG. 1 can be implemented by the execution of the program by the CPU 701. However, at least part of the individual functional units shown in FIG. 1 may be implemented by dedicated hardware or a GPU which is not shown. In this case, the dedicated hardware or GPU operates based on the control of the CPU 701.

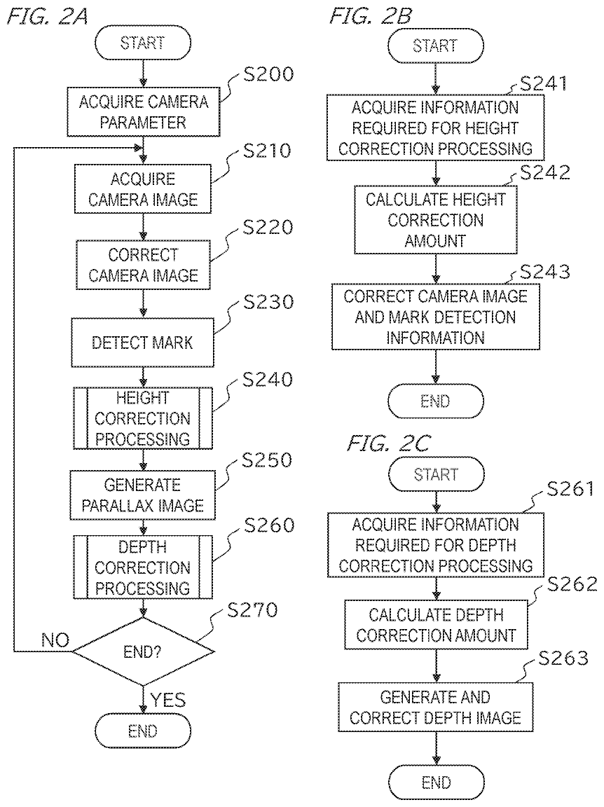

Next, processing executed by the information processing apparatus 101 will be described with reference to FIG. 2A. FIG. 2A is a flowchart showing the processing executed by the information processing apparatus 101. The processing in FIG. 2A is performed for each frame. Note that the detail of the processing executed by each functional unit is as described above, and a duplicate description will be omitted in each step described below.

In Step S200, the information processing apparatus 101 acquires the camera parameter from the imaging unit 100, and stores the camera parameter in the storage unit 130. Note that the present embodiment is not limited to the acquisition of the camera parameter from the imaging unit 100, and a result obtained by calibrating the camera parameter in advance may be stored in the storage unit 130.

In Step S210, the image acquisition unit 110 acquires the camera image from the imaging unit 100.

In Step S220, the image correction unit 120 performs the correction processing on the camera image (each of the left image and the right image) acquired in Step S210 by using the camera parameter stored in the storage unit 130. Subsequently, the image correction unit 120 stores the camera image after correction (before height correction) in the storage unit 130.

In Step S230, the mark detection unit 150 detects the mark from the camera image after correction (before height correction) stored in the storage unit 130, and stores the information on the detected mark (mark detection information) in the storage unit 130.

In Step S240, the height correction processing unit 190 executes a series of height correction processing operations from the acquisition of the height correction amount to the height correction. The detail of the height correction processing in Step S240 will be described later by using FIG. 2B.

In Step S250, the parallax image generation unit 140 calculates the parallax in the camera image after correction based on the camera image after correction (after height correction) and the camera parameter stored in the storage unit 130, generates the parallax image, and stores the parallax image in the storage unit 130.

In Step S260, the depth correction processing unit 160 executes a series of depth correction processing operations from the acquisition of the depth correction amount to the depth correction. The detail of the depth correction processing in Step S260 will be described later by using FIG. 2C.

In Step S270, the information processing apparatus 101 determines whether or not an end condition is satisfied. For example, in the case where an end instruction is input from a user, the information processing apparatus 101 determines that the end condition is satisfied. In the case where the end condition is satisfied, the processing is ended. In the case where the end condition is not satisfied, the processing is moved to Step S210.

FIG. 2B is a flowchart showing the detail of the height correction processing in Step S240.

In Step S241, the height correction processing unit 190 acquires, as information required for the height correction processing, the camera parameter, the camera image after correction (before height correction), the mark detection information (before height correction), and the mark information from the storage unit 130.

In Step S242, the height correction amount calculation unit 191 calculates the height correction amount as described above based on the information acquired in Step S241.

In Step S243, the height correction unit 195 corrects the camera image after correction and the mark detection information by using the height correction amount calculated in Step S242 (height correction).

FIG. 2C is a flowchart showing the detail of the depth correction processing in Step S260.

In Step S261, the depth correction processing unit 160 acquires, as information required for the depth correction processing, the camera parameter, the parallax image, the mark detection information (after height correction), and the mark information from the storage unit 130.

In Step S262, the depth correction amount calculation unit 161 calculates the depth correction amount as described above based on the information acquired in Step S261.

In Step S263, the depth image generation unit 165 generates the depth image based on the information acquired in Step S261, and corrects the depth image by using the depth correction amount calculated in Step S262.

As has been described thus far, according to the present embodiment, in a series of the processing operations performed until the final depth image is obtained, the height correction amount based on the positional relationship in the height direction between the mark in the left image and the mark in the right image is used. For example, the left image and the right image are corrected with the height correction amount. With this, it is possible to implement the state in which the stereo rectification is performed properly (with high accuracy). By extension, it becomes possible to perform preferable stereo matching (stereo matching which refers to, in the other image, the position having the same height as that of a given pixel in one of images), and it is possible to obtain the depth image with high accuracy in a short time period.

Note that, in the present embodiment, the description has been given of the example in which the depth correction amount is calculated from the information on the adjacent vertices 310A and 310D (the vertices 310E and 310H) in the rectangular area, but the present embodiment is not limited thereto. For example, from among four vertices of the rectangular area, any two vertices may also be selected. In addition, the depth correction amount may be calculated by using a distance between two vertices in one of a plurality of combinations selected from four vertices of the rectangular area. In this case, a plurality of the depth correction amounts are calculated and, for example, an average of the depth correction amounts may be appropriately used.

In addition, in the case where two vertices are selected, it is preferable to select two vertices having a long distance between the two vertices on the camera image after correction (the left image 321L or the right image 321R). When the distance between the two vertices on the image is short, a sampling error occurs in processing of straight line fitting used when information on the vertex is determined, and an estimated vertex tends to include an error in many cases.

Further, the present invention is not limited to the calculation of the depth correction amount from the image photographed at one location. The present invention can also be applied to cameras other than the fixed-viewpoint stereo camera. As described in Japanese Patent Application Publication No. 2012-058188, images photographed at two locations may also be used.

In addition, the three-dimensional position of the mark is not required as the mark information prepared in advance, and hence it is not necessary to fix the mark in space, and the mark may move in space to be observed. For example, only by photographing the mark held by a hand with the imaging unit 100 at a timing when the user desires to correct the depth value, the depth correction is completed. Consequently, it is possible to simplify a configuration for the depth correction and knowledge about maintenance becomes unnecessary, which contributes to a reduction in maintenance cost.

Further, in the present embodiment, the description has been given of the example in which the depth correction amount is calculated and the depth value is corrected, but the parallax for obtaining the depth value may also be corrected. In this case, it is only required that the depth value is determined from the corrected parallax, and it is not necessary to correct the depth value. As the correction of the parallax, it is only required that the difference of the parallax is calculated from the difference 530 of the Z value, and the difference of the parallax is added to the parallax.

Further, in the present embodiment, the description has been given of the example in which the camera image is corrected with the height correction amount, but the present embodiment is not limited thereto, and the stereo matching may also be performed in consideration of the height correction amount. For example, the parallax may be calculated by moving a search line of the stereo matching only by an amount corresponding to the height correction amount. In addition, the internal parameter itself may be changed based on the height correction amount, and the depth value may be calculated by using epipolar geometry without performing the stereo rectification.

In addition, in the present embodiment, the description has been given of the example in which the depth correction is performed based on the positional relationship after height correction between the mark (vertex) in the left image and the mark (vertex) in the right image, but the present embodiment is not limited thereto. For example, the depth correction may be performed based on the positional relationship before height correction between the mark (vertex) in the left image and the mark (vertex) in the right image and the height correction amount without correcting the mark detection information.

### Second Embodiment

Hereinbelow, a second embodiment of the present invention will be described. In the first embodiment, the description has been given of the example in which the height correction amount is calculated for each frame in the height correction processing unit 190, and the camera image after correction and the mark detection information are corrected (updated) with the height correction amount. In the second embodiment, a description will be given of an example in which the correction (update) of the camera image after correction and the mark detection information is not performed, and the image correction unit 120 performs the image correction in which the height correction amount calculated in the immediately preceding frame is reflected. Note that, in the following description, points (configurations and processing) different from those in the first embodiment will be described in detail, and the description of points similar to those in the first embodiment will be appropriately omitted.

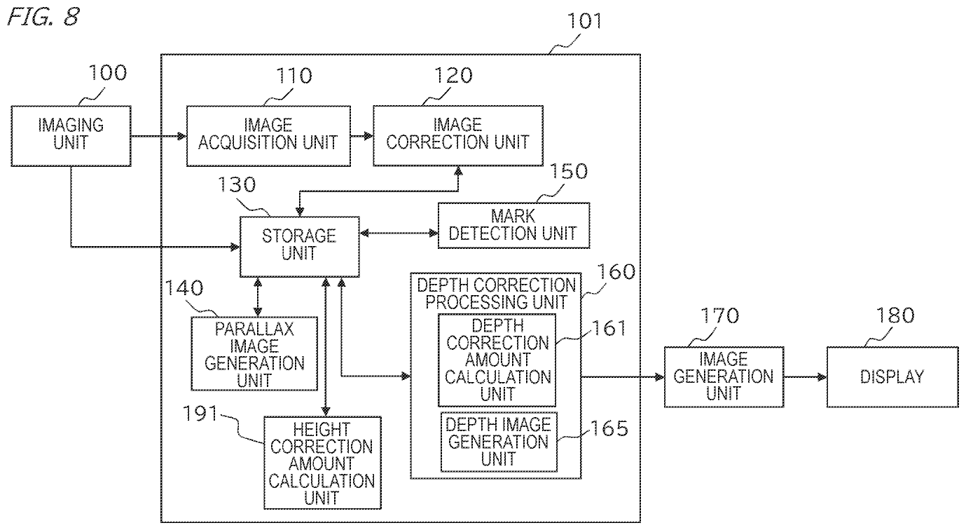

FIG. 8 is a block diagram showing a functional configuration of a photographing system according to the second embodiment. The second embodiment is different from the first embodiment (FIG. 1) in that the information processing apparatus 101 has the height correction amount calculation unit 191 instead of the height correction processing unit 190, i.e., the information processing apparatus 101 does not have the height correction unit 195. The other configurations are the same as those in the first embodiment.

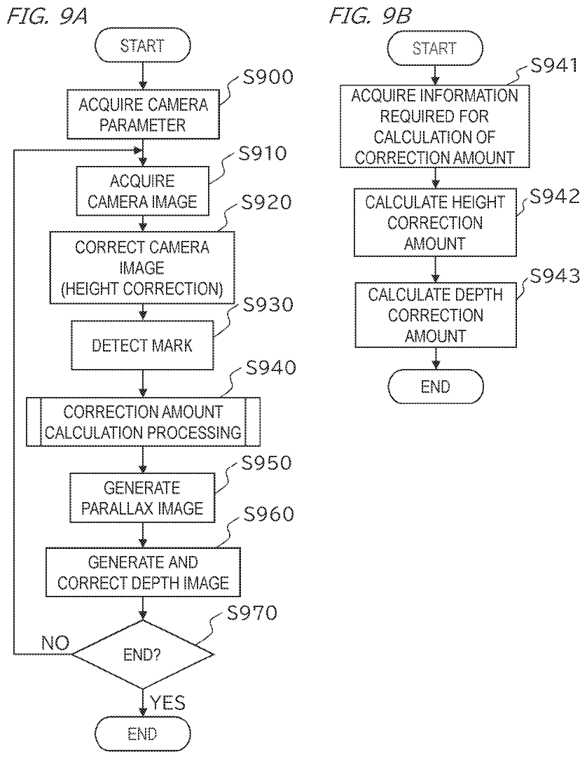

Processing executed by the information processing apparatus 101 in the second embodiment will be described with reference to FIG. 9A. FIG. 9A is a flowchart showing the processing executed by the information processing apparatus 101 in the second embodiment. The processing in FIG. 9A is performed for each frame. Note that, in the following description, processing in a state in which the storage unit 130 stores the height correction amount (processing in second and subsequent frames) will be described as the processing in FIG. 9A.

In Step S900, the information processing apparatus 101 acquires the camera parameter from the imaging unit 100, and stores the camera parameter in the storage unit 130. Note that the present embodiment is not limited to the acquisition of the camera parameter from the imaging unit 100, and a result obtained by calibrating the camera parameter in advance may be stored in the storage unit 130.

In Step S910, the image acquisition unit 110 acquires the camera image from the imaging unit 100.

In Step S920, the image correction unit 120 performs the correction processing on the camera image (each of the left image and the right image) acquired in Step S910 by using the camera parameter and the height correction amount stored in the storage unit 130. Subsequently, the image correction unit 120 stores the camera image after correction (after height correction) in the storage unit 130.

In Step S930, the mark detection unit 150 detects the mark from the camera image after correction (after height correction) stored in the storage unit 130, and stores the information on the detected mark (mark detection information) in the storage unit 130. In the present embodiment, the camera image after height correction is obtained in Step S920, and hence the information after height correction is obtained as the mark detection information in Step S930.

In Step S940, correction amount calculation processing is executed. The detail of the correction amount calculation processing in Step S940 will be described later by using FIG. 9B.

In Step S950, the parallax image generation unit 140 calculates the parallax in the camera image after correction based on the camera image after correction (after height correction) and the camera parameter stored in the storage unit 130, generates the parallax image, and stores the parallax image in the storage unit 130.

In Step S960, the depth image generation unit 165 generates the depth image based on information (including the parallax image generated in Step S950) stored in the storage unit 130, and corrects the depth image by using the depth correction amount stored in the storage unit 130.

In Step S970, the information processing apparatus 101 determines whether or not the end condition is satisfied. For example, in the case where the end instruction is input from the user, the information processing apparatus 101 determines that the end condition is satisfied. In the case where the end condition is satisfied, the processing is ended. In the case where the end condition is not satisfied, the processing is moved to Step S910.

Note that the height correction amount is not stored in the storage unit 130 in the first frame, and hence the height correction amount is not used in Step S920, and the camera image before height correction is obtained and is stored in the storage unit 130. Even when it is not possible to perform the correction with the height correction amount in the first frame, it is possible to perform the correction with the height correction amount in second and subsequent frames, and hence there is no problem.

FIG. 9B is a flowchart showing the detail of the correction amount calculation processing in Step S940.

In Step S941, the height correction amount calculation unit 191 acquires information required for the calculation of the height correction amount from the storage unit 130, and the depth correction amount calculation unit 161 acquires information required for the calculation of the depth correction amount from the storage unit 130.

In Step S942, the height correction amount calculation unit 191 calculates the height correction amount as described in the first embodiment based on the information acquired in Step S941, and stores the height correction amount in the storage unit 130. In the case where the storage unit 130 stores the height correction amount (the height correction amount in the immediately preceding frame), the height correction amount calculation unit 191 updates the height correction amount in the storage unit 130 with the calculated height correction amount.

In Step S943, the depth correction amount calculation unit 161 calculates the depth correction amount as described in the first embodiment based on the information acquired in Step S941, and stores the depth correction amount in the storage unit 130. In the case where the storage unit 130 stores the depth correction amount (the depth correction amount in the immediately preceding frame), the depth correction amount calculation unit 161 updates the depth correction amount in the storage unit 130 with the calculated depth correction amount.

As has been described thus far, according to the second embodiment, the correction (update) of the camera image after correction and the mark detection information is not performed, and the image correction unit 120 performs the image correction in which the height correction amount calculated in the immediately preceding frame is reflected. With this, it is possible to make a calculation load lower than that in the first embodiment. The camera parameter does not change significantly in one frame, and hence there is no problem even when the height correction amount calculated in the immediately preceding frame is used.

Note that the description has been given of the example in which the correction amount calculation processing in Step S940 is performed for each frame, but the correction amount calculation processing may also be performed every plural frames.

Note that the above-described embodiments (including modifications) are only exemplary, and configurations obtained by appropriately modifying or changing the above-described configurations within the scope of the gist of the present invention are also included in the present invention. Configurations obtained by appropriately combining the above-described configurations are also included in the present invention.

According to the present invention, it is possible to obtain the depth position of the photographed scene and the parallax corresponding to the depth position with high accuracy in a short time period.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-021445, filed on Feb. 15, 2022, which is hereby incorporated by reference herein in its entirety.

What is claimed is:

1. An information processing apparatus comprising at least one memory and at least one processor and/or at least one circuit which function as:
an image acquisition unit configured to acquire a first image captured from a first direction and a second image captured from a second direction;
a mark detection unit configured to detect a mark from each of the first image and the second image;
a correction value acquisition unit configured to acquire a correction value for at least one of the first image and the second image on a basis of a positional relationship in a height direction between the mark in the first image and the mark in the second image;
a parallax determination unit configured to determine a parallax between the first image and the second image on a basis of the first image, the second image, and the correction value; and
a correction unit configured to correct the parallax determined by the parallax determination unit or a depth position corresponding to the parallax on a basis of a positional relationship between the mark in the first image and the mark in the second image and the correction value, wherein
the correction value includes at least one of a correction value for enlarging or reducing at least one of the first image and the second image and a correction value for moving at least one of the first image and the second image in the height direction.

2. The information processing apparatus according to claim 1, wherein
the parallax determination unit determines, on a basis of the first image and the second image after correction with the correction value, the parallax between the first image and the second image after the correction.

3. The information processing apparatus according to claim 1, wherein
the correction unit corrects the parallax or the depth position on a basis of a positional relationship between the mark in the first image and the mark in the second image after correction with the correction value.

4. The information processing apparatus according to claim 1, wherein
the mark detection unit detects a mark from each of the first image and the second image after correction with the correction value.

5. The information processing apparatus according to claim 1, wherein
the at least one memory and the at least one processor and/or the at least one circuit further function as a position correction unit configured to correct position information of at least one of the mark in the first image and the mark in the second image on a basis of the correction value.

6. The information processing apparatus according to claim 1, wherein
the at least one memory and the at least one processor and/or the at least one circuit further function as an image correction unit configured to correct at least one of the first image and the second image on a basis of the correction value.

7. The information processing apparatus according to claim 1, wherein
the correction value acquisition unit acquires the correction value for reducing a positional displacement in a height direction between the mark in the first image and the mark in the second image.

8. The information processing apparatus according to claim 1, wherein
the correction value acquisition unit acquires the correction value for minimizing change amounts in the first image and the second image due to correction with the correction value.

9. An information processing method comprising:
acquiring a first image captured from a first direction and a second image captured from a second direction;
detecting a mark from each of the first image and the second image;
acquiring a correction value for at least one of the first image and the second image on a basis of a positional relationship in a height direction between the mark in the first image and the mark in the second image;
determining a parallax between the first image and the second image on a basis of the first image, the second image, and the correction value; and
correcting the parallax or a depth position corresponding to the parallax on a basis of a positional relationship between the mark in the first image and the mark in the second image and the correction value, wherein
the correction value includes at least one of a correction value for enlarging or reducing at least one of the first image and the second image and a correction value for moving at least one of the first image and the second image in the height direction.

10. A non-transitory computer readable medium that stores a program, wherein the program causes a computer to execute an information processing method comprising:
acquiring a first image captured from a first direction and a second image captured from a second direction;
detecting a mark from each of the first image and the second image;
acquiring a correction value for at least one of the first image and the second image on a basis of a positional relationship in a height direction between the mark in the first image and the mark in the second image;
determining a parallax between the first image and the second image on a basis of the first image, the second image, and the correction value; and
correcting the parallax or a depth position corresponding to the parallax on a basis of a positional relationship between the mark in the first image and the mark in the second image and the correction value, wherein
the correction value includes at least one of a correction value for enlarging or reducing at least one of the first image and the second image and a correction value for moving at least one of the first image and the second image in the height direction.
